(19) United States
(12) Patent Application Publication
(10) Pub. No.: US 2011/0299041 A1
(43) Pub. Date: Dec. 8, 2011

(54) AIR FILTER DEVICE AND VIDEO PROJECTOR USING AIR FILTER DEVICE

(75) Inventors: Yosuke Nishihata, Hirakata-shi (JP); Akira Miyanaga, Daito-shi (JP); Yoshiharu Arioka, Osaka-shi (JP); Hideaki Okaniwa, Nagoya-shi (JP)

(73) Assignee: SANYO ELECTRIC CO., LTD., Osaka (JP)

(21) Appl. No.: 13/153,870

(22) Filed: Jun. 6, 2011

(30) Foreign Application Priority Data
Jun. 8, 2010 (JP) 2010-131290

(51) Int. Cl. G03B 21/16; B01D 46/42

(52) U.S. Cl. 353/52; 55/295

(57) ABSTRACT

An air filter device including a base, air filter, and self-propelled cleaning unit. The base includes a frame defining an opening through which air is drawn. The air filter captures dust from the air passing through the opening. The air filter is fastened to the frame by a fastener and includes an filter surface. The self-propelled cleaning unit is coupled to the base, moves along the filter surface when cleaning the first air filter, and is located at a standby position on the frame of the base when in a non-cleaning state. The self-propelled cleaning unit, which includes a cleaning brush, a dust box, and a motor, lies away from the entire filter surface of the first air filter and the fastener when located at the standby position.

### CROSS-REFERENCE TO RELATED APPLICATIONS

This application is based upon and claims the benefit of priority from prior Japanese Patent Application No. 2010-131290, filed on Jun. 8, 2010, the entire contents of which are incorporated herein by reference.

### BACKGROUND OF THE INVENTION

The present invention relates to an air filter device and a video projector that uses the air filter device.

A video projector typically cools optical elements such as a light source lamp and light valves with cooling air. The cooling air may be ambient air that is drawn into the video projector through an air inlet formed in an outer case of the video projector. Dust, which is suspended in the cooling air, may collect on optical elements such as liquid crystal panels and lower the quality of a projected image. Thus, an air filter is arranged in the air inlet to capture the dust that is suspended in the air.

When used for a long period of time, the filter may clog. Clogging of the air filter increases the intake resistance at the air inlet and reduces the amount of cooling air delivered to the optical elements. This results in insufficient cooling of the optical elements, such as the liquid crystal panels. It is thus preferable that the air filter be frequently cleaned. However, a video projector may be used in various positions. Thus, depending on where and how the video projector is oriented, it may be difficult to manually clean the air filter. To cope with this problem, Japanese Laid-Open Patent Publication No. 2008-65021 describes a video projector including an air filter cleaning device that automatically cleans the air filter.

The video projector of the '021 publication includes a filter unit that automatically cleans a pre-filter, which is coupled in a removable manner to the air inlet (inlet for ambient air). The filter unit includes a mechanical drive unit, which moves the pre-filter during cleaning in a constant direction along an air intake plane, brushes, which are fixed to hold the air filter in between, and a secondary air filter, which captures small particles of dust. The longitudinal direction of the brush is orthogonal to the moving direction of the pre-filter. When the pre-filter moves, the brushes clean opposite sides of the pre-filter.

Japanese Laid-Open Patent Publication No. 2009-82837 proposes an air filter device that automatically removes dust from an air filter of an air conditioner. The air conditioner is provided with a dust remover, which includes a rotation brush that removes dust from the air filter, a dust box, which collects the dust removed by the rotation brush, and a motor. The dust remover removes dust from the surface of the air filter with the rotation brush while vertically moving the air filter.

### SUMMARY OF THE INVENTION

In the video projector of the '021 publication, the pre-filter is moved through the brushes, which are fixed to the central part of the filter unit. Thus, a large space is used to accommodate the pre-filter. Further, the dust removed from the pre-filter is not collected. Thus, the dust removed from the pre-filter is apt to being scattered. As a result, although the filter unit allows for a decrease in the frequency of manual maintenance, such as the cleaning and replacement of the air filter, manual maintenance is still necessary. Further, in the '021 publication, the brushes interfere with maintenance of the pre-filter.

In the air-conditioner of the '837 publication, the movable dust remover cleans the fixed air filter. Thus, the air filter may be accommodated in a small space. However, in the air-conditioner of the '837 publication, the dust remover always lies over the air filter and hinders maintenance. Further, the dust remover interferes with maintenance of the pre-filter.

One aspect of the present invention is an air filter device provided with a base including a frame that defines an opening through which air is drawn. A first air filter captures dust from the air drawn through the opening. The first air filter is fastened to the frame of the base by a fastener, and the first air filter includes a filter surface. A self-propelled cleaning unit is coupled to the base. The self-propelled cleaning unit moves along the filter surface of the first air filter when cleaning the first air filter and is located at a standby position on the frame of the base when in a non-cleaning state. The self-propelled cleaning unit includes a cleaning brush, which removes dust from the first air filter, a dust box, which collects dust removed by the cleaning brush, and a motor, which moves the self-propelled cleaning unit. The self-propelled cleaning unit, when located at the standby position, lies away from the entire filter surface of the first air filter and the fastener.

In the description hereafter, the position at which a self-propelled cleaning unit is located in a standby state when cleaning is not performed is referred to as a standby position or home position. A structure for coupling the air filter to a frame of a base is referred to as a fastener. The fastener may be a fastening structure formed by, for example, screws, or an engagement structure formed by, for example, elastic hooks.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a video projector that uses an air filter device according to one embodiment of the present invention;

FIG. 2 is a schematic plan view showing an optical system in the video projector of FIG. 1;

FIG. 3 is a side view showing the video projector of FIG. 1;

FIG. 4(a) is a side view showing the video projector oriented in an upward projection state, FIG. 4(b) is a side view showing the video projector in a ceiling-suspended projection state, and FIG. 4(c) is a side view showing the video projector in a downward projection state;

FIG. 5 is a perspective view showing the air filter device and a self-propelled cleaning unit located at a standby position;

FIG. 6 is a plan view showing the air filter device of FIG. 5;

FIG. 7 is an exploded perspective view showing the air filter device of FIG. 5;

FIG. 8 is a perspective view showing the air filter device in cross-section along line A-A in FIG. 1;

FIG. 9 is a perspective view showing the air filter device in cross-section along line B-B in FIG. 6;

FIG. 10 is a perspective view showing the air filter device in cross-section along line C-C in FIG. 6;

FIG. 11 is an enlarged view showing the self-propelled cleaning unit in the air filter device of FIG. 5;

FIG. 12 is a perspective view showing the self-propelled cleaning unit located at a return position;

FIG. 13 is a cross-sectional view of the air filter device taken along line D-D in FIG. 6;

FIG. 14 is a cross-sectional view of the air filter device taken along line D-D in FIG. 6;

FIG. 15 is a cross-sectional view showing the moving self-propelled cleaning unit; and

FIG. 16 is a cross-sectional view showing the self-propelled cleaning unit returning to the standby position.

### DETAILED DESCRIPTION OF THE INVENTION

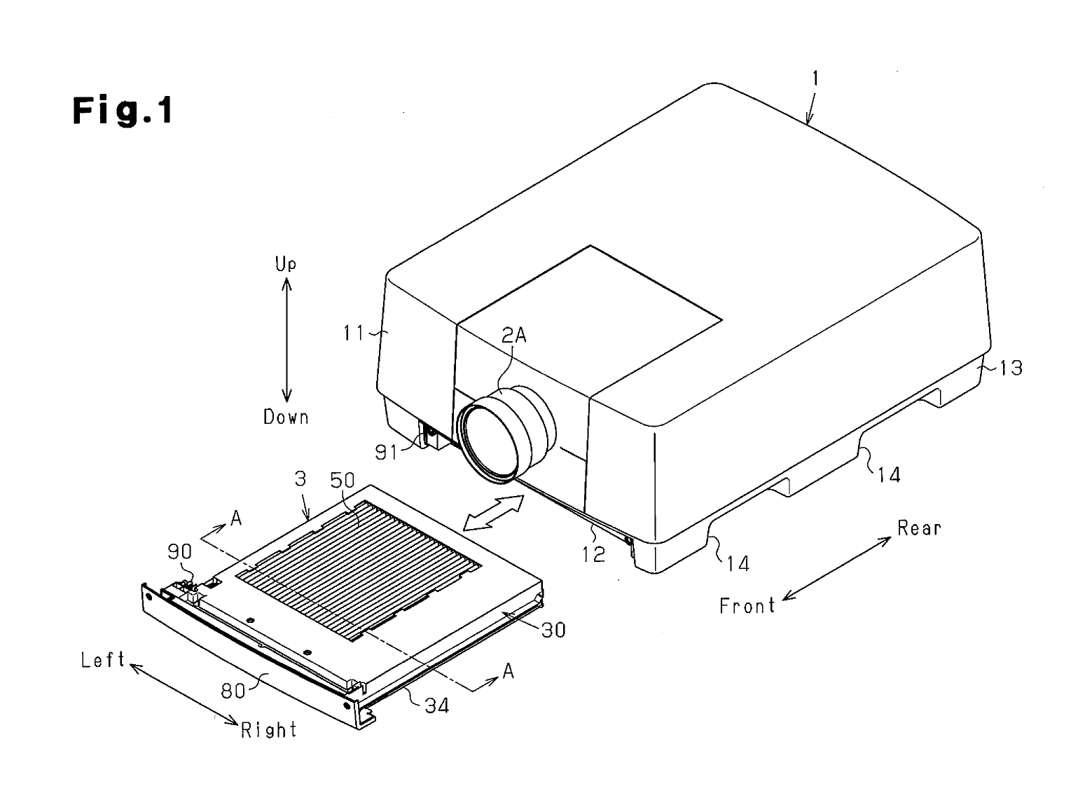

A video projector according to one embodiment of the present invention will now be discussed with reference to the drawings. FIG. 1 shows a state in which the video projector is set upright. In the description hereafter, unless otherwise indicated, the upper, lower, left, right, front, and rear directions are as indicated by the arrows shown in FIG. 1.

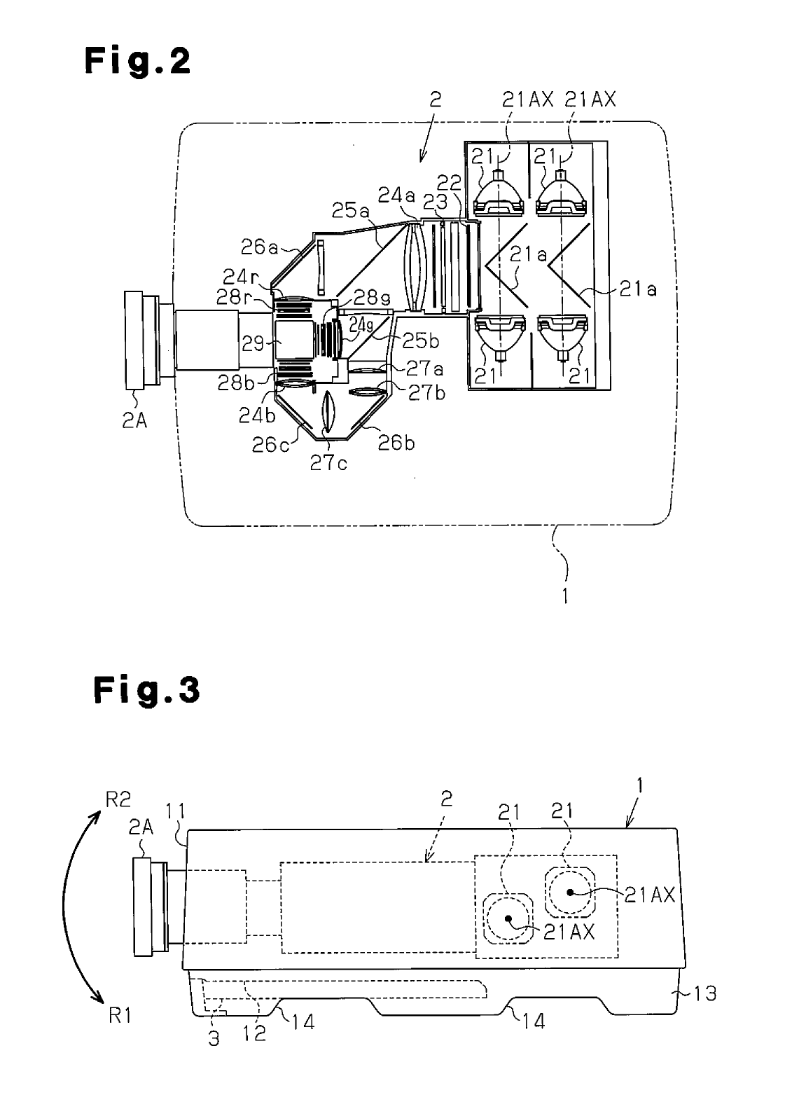

The video projector is, for example, a three-LCD type video projector. The projector includes an outer case 1. The outer case 1 accommodates an optical system 2 such as that shown in FIG. 2. A projection lens 2A extends from a front wall 11 of the outer case 1. A filter unit 3 is arranged in an air inlet 12 of the outer case 1. The filter unit 3 can be slid out from the front wall 11 of the outer case 1. The filter unit 3 includes an upstream side that is in communication with the exterior of the projector through a plurality of slits 14, which are arranged in a side wall 13 of the outer case 1. Ambient air flows into the outer case 1 as cooling air through the slits 14 and the upstream side of the filter unit 3.

Referring to FIG. 2, the optical system 2 includes four light source lamps 21, which serve as a light source and are each formed by a discharge lamp. Each lamp 21 has an optical axis 21AX, which is substantially parallel to the front wall 11 of the outer case 1. The illumination light generated by the four light source lamps 21 are combined by optical path changing members 21a and emitted in a predetermined direction (e.g., frontward direction).

An integrator lens 22, polarizing beam splitter 23, and condenser lens 24a guide the illumination light to a color separation optical system, which separates the illumination light into three colors of light, namely, red light, green light, and blue light. The color separation optical system includes, for example, two dichroic mirrors 25a and 25b, three total reflection mirrors 26a, 26b, and 26c, three relay lenses 27a, 27b, and 27c, and three condenser lenses 24r, 24g, and 24b. Red, green, and blue liquid crystal light valves 28r, 28g, and 28b respectively perform optical modulation on the red light, green light, and blue light. A cross-dichroic prism 29 combines the modulated light into image light, which is emitted from the projection lens 2A. Some of the elements in the optical system 2 require to be cooled by the cooling air. The elements that are to be cooled are, for example, the lamps 21, the liquid crystal panels and polarization plates of the liquid crystal light valves 28r, 28g, and 28b, and the polarizing beam splitter 23. Of these, the lamps 21 become the hottest.

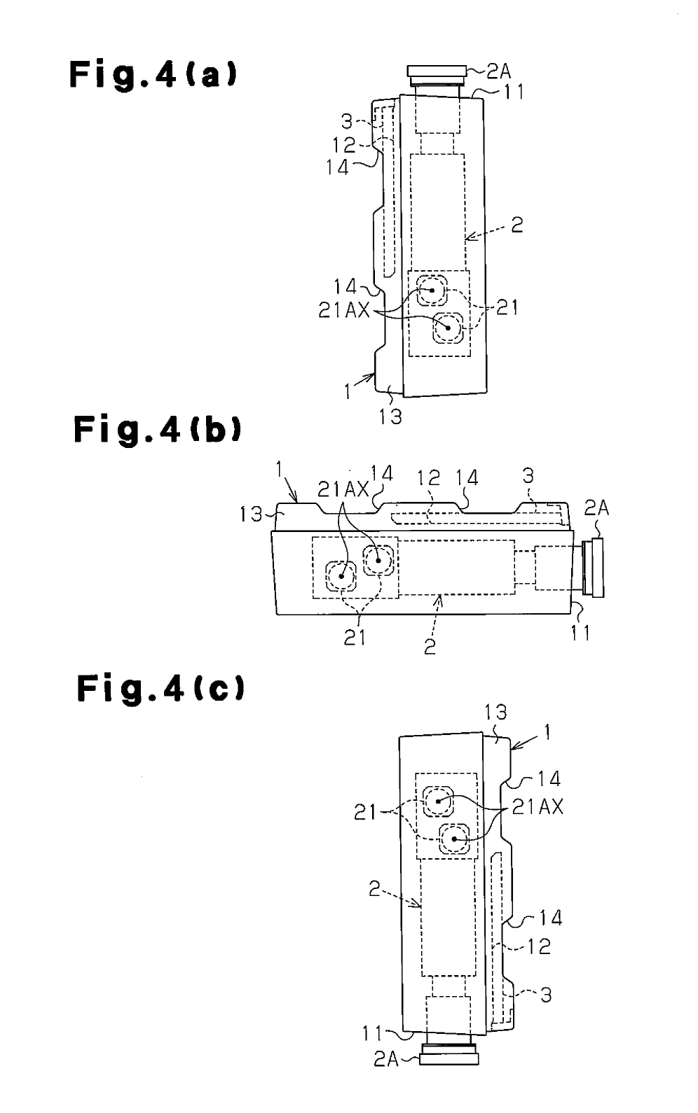

The video projector may be set in an upright projection state as shown in FIG. 3. The video projector may also be set in a state rotated from the state of FIG. 3 in the directions of arrows R1 and R2 so that the optical axis 21AX of each lamp 21 is always horizontal. For example, the video projection may be set in an upward projection state shown in FIG. 4(a), a suspended projection state shown in FIG. 4(b), or a downward projection state shown in FIG. 4(c). In this manner, the use of the video projector in a state in which the optical axis 21AX of each lamp 21 is always horizontal prevents excessive heating of the lamp 21.

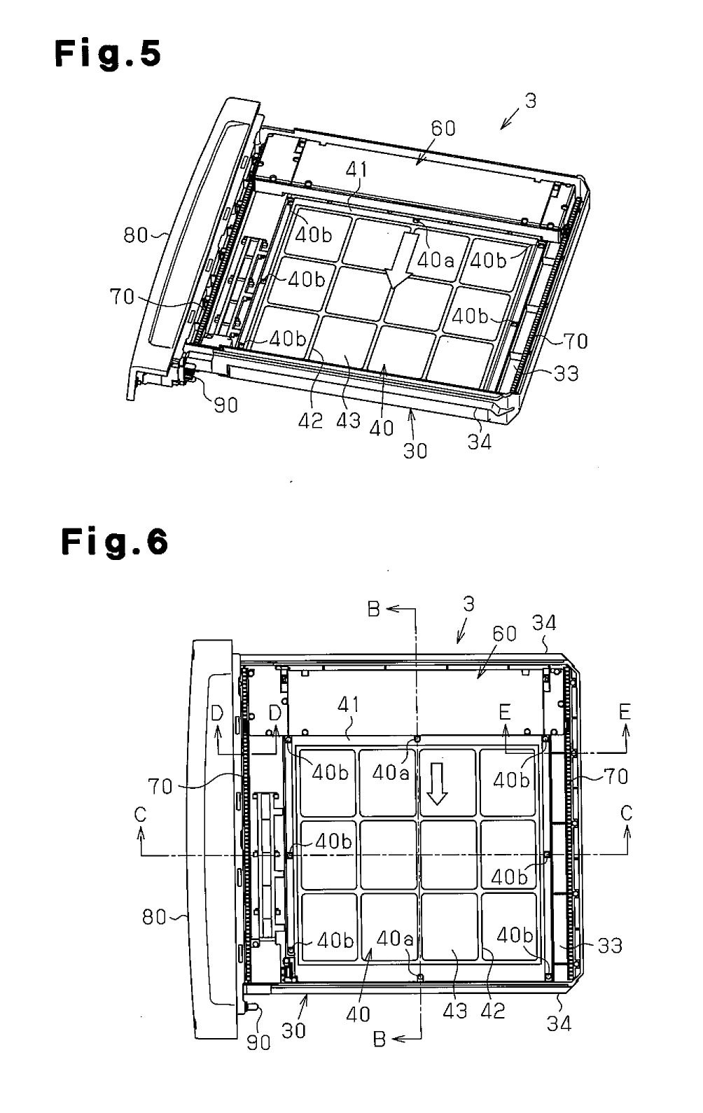

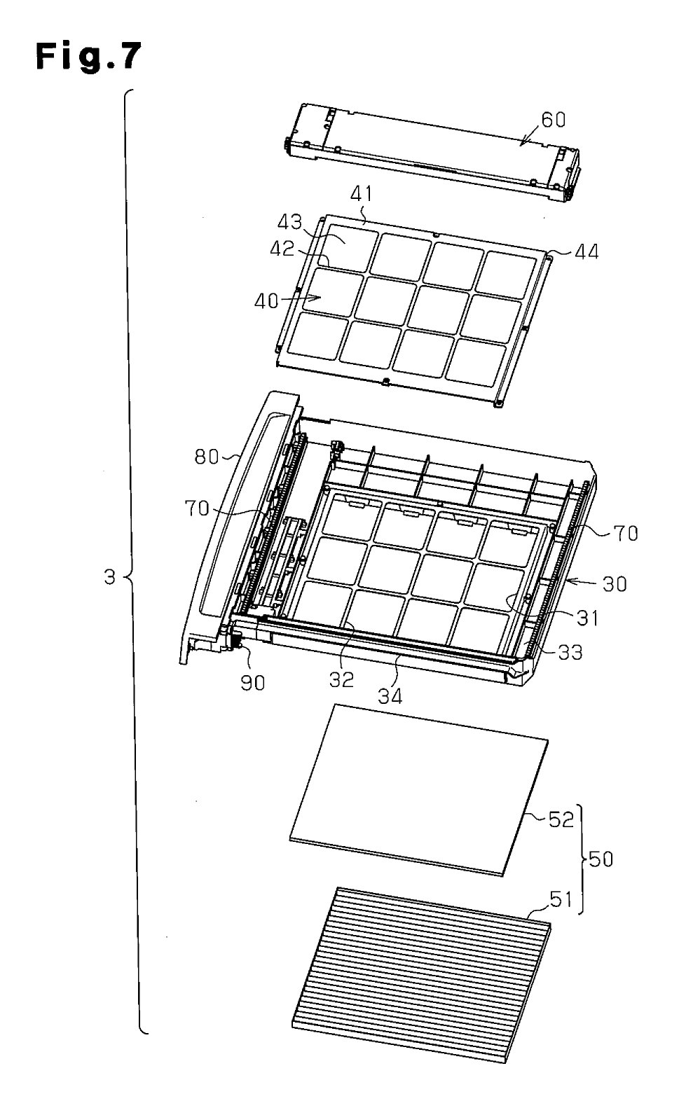

FIG. 1 shows the video projector in a state in which the filter unit 3 is drawn out from the front wall 11. FIGS. 5 and 6 show the bottom surface of the filter unit 3. Referring to FIG. 7, the filter unit 3 includes a base 30, a first air filter 40, a second air filter 50, a self-propelled cleaning unit (automatic cleaning unit) 60, two racks 70, and a handle 80. The first air filter 40, cleaning unit 60, and racks 70 may be arranged at an upstream side of the base 30. The second air filter 50 may be arranged at the downstream side of the base 30. The handle 80 may be arranged at the front of the base 30.

Referring to FIG. 7, the base 30 includes a frame 33 and a grid 32. The frame 33 includes an opening 31, which serves as a cooling air intake port. The grid 32 is coupled to the frame 33. The frame 33 and grid 32 may be formed integrally with each other. The base 30 may be a molded resin product.

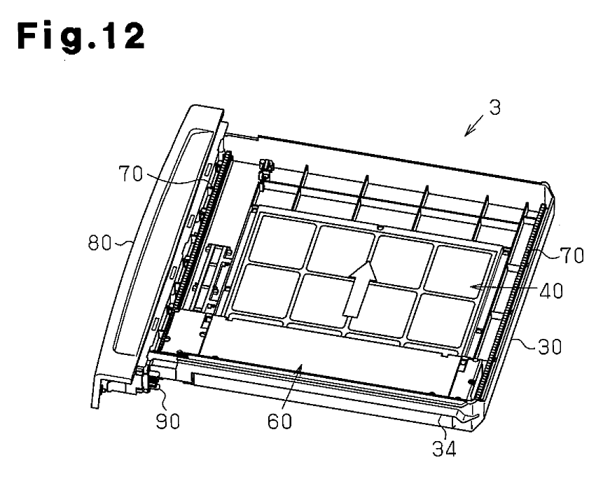

The handle 80 is coupled to the frame 33 of the base 30. The cleaning unit 60 is coupled to the base 30 in a movable manner. FIGS. 5 and 6 shown the self-propelled cleaning unit 60 arranged at an initial position or standby position. The self-propelled cleaning unit 60 moves back and forth between the standby position and a return position, or remote position, which is shown in FIG. 12. In the illustrated example, the standby position and the return position of the self-propelled cleaning unit 60 are respectively located at the right and left ends of the base 30. The base 30 includes left and right walls each forming a rail 34. The filter unit 3 slides along the rails 34 in the outer case 1. The two racks 70 are coupled to the upstream side of the base 30. The racks 70 are located at opposite sides of the opening 31 near the front and rear ends of the base 30. The self-propelled cleaning unit 60 moves in engagement with the two racks 70.

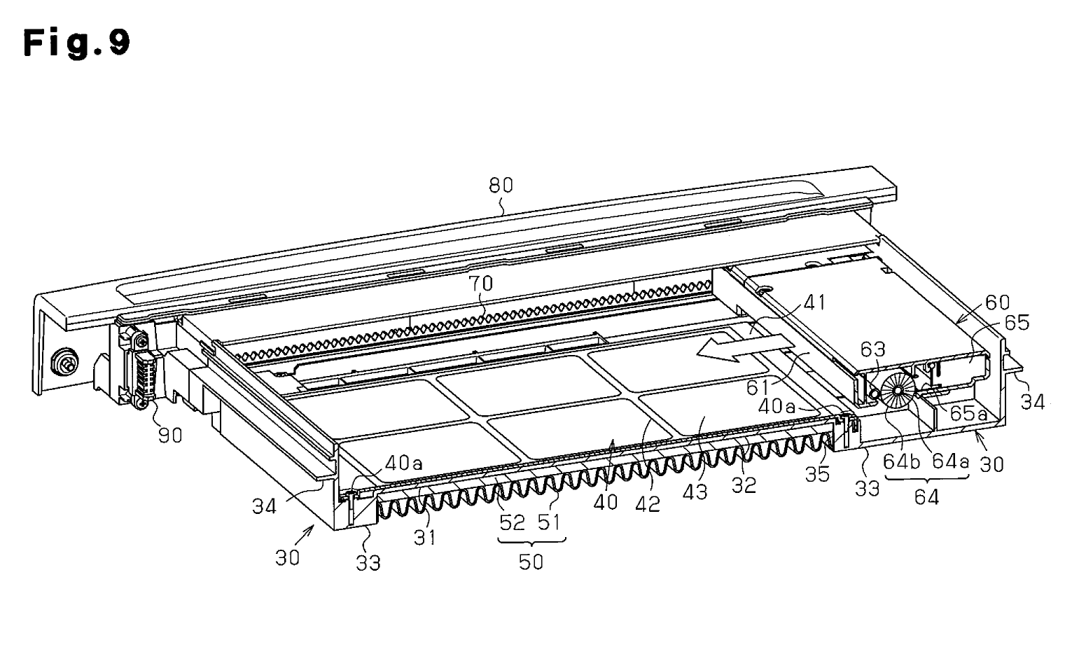

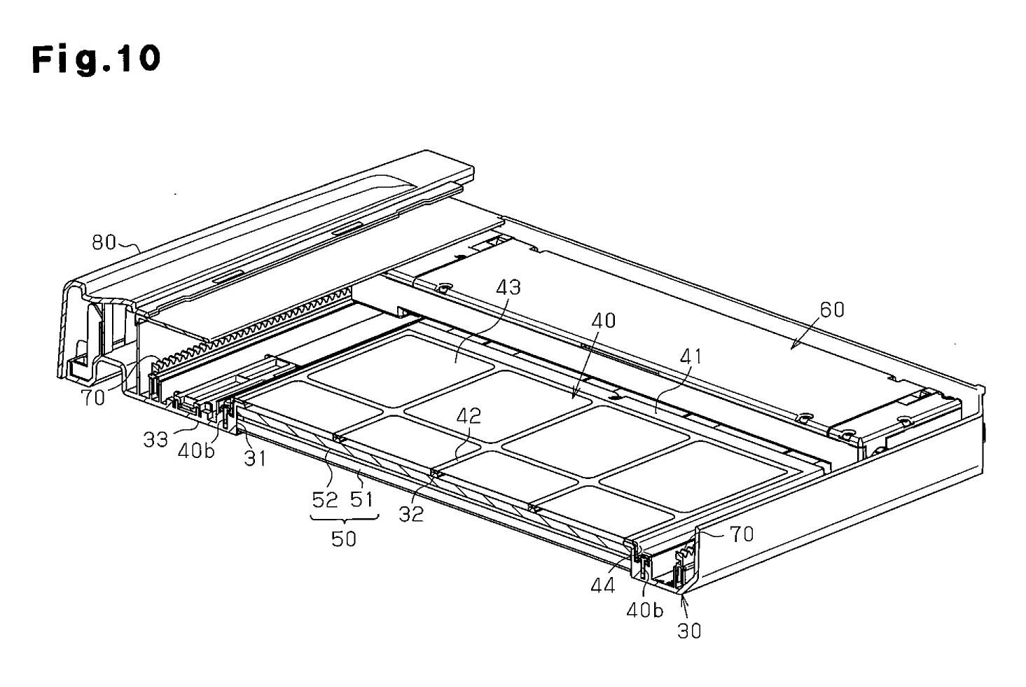

The first air filter 40 is coupled to the upstream side of the base 30 at a position corresponding to the opening 31. As shown in FIG. 7, the first air filter 40 includes a rim 41, a grid 42, and a porous filtering element 43, which are formed integrally with one another. The rim 41 may include a bent portion 44 to increase rigidity and strength. As shown in FIGS. 5 and 6, fasteners fasten the rim 41 of the first air filter 40 to the frame 33 of the base 30. The fasteners may be screws 40a and 40b, which extend perpendicular to the filtering surface of the first air filter 40. As shown in FIG. 9, the screws 40a fasten the rim 41 to upstream projections formed on the frame 33. As shown in FIG. 10, the screws 40b fasten the rim 41 to the upstream side of the frame 33 from positions that are deeper than the upstream projections. As shown in FIGS. 6, 8, and 9, the filtering surface of the first air filter 40 and the fasteners (screws 40a and 40b) are arranged so that they do lie away from the self-propelled cleaning unit 60 when located at the standby position. In the example shown in FIG. 6, the self-propelled cleaning unit 60, which is located at the standby position, does not cover any part of the filtering surface of the first air filter 40 and the fasteners (40a and 40b). In this state, the self-propelled cleaning unit 60 covers only the frame 33, which is located outward from the opening 31.

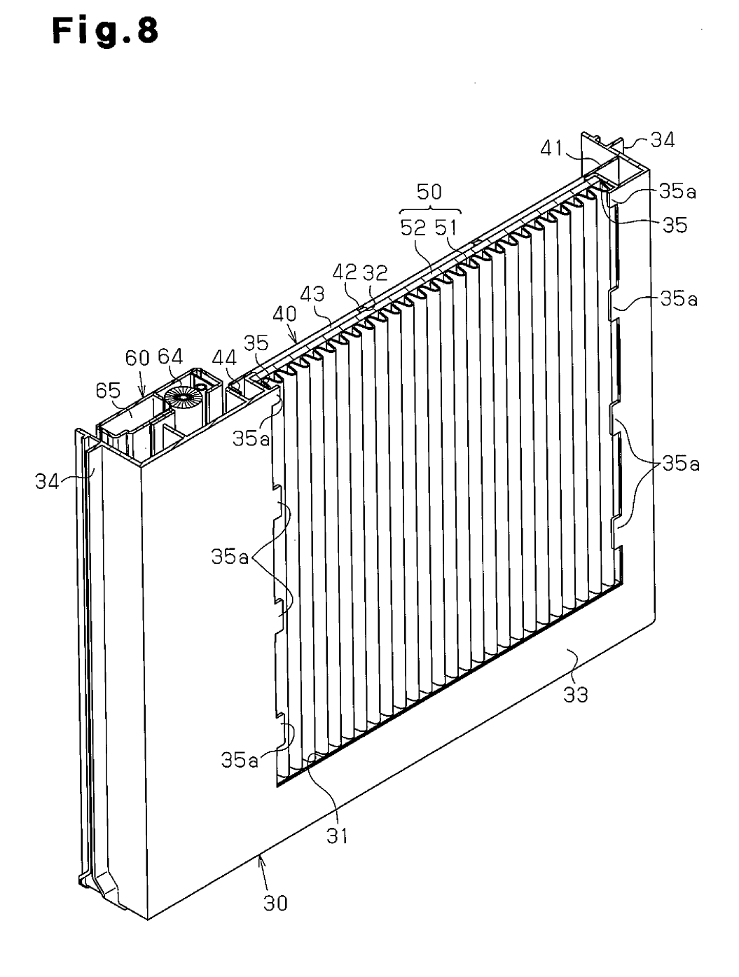

The second air filter 50 is coupled to the downstream side of the base 30 in correspondence with the opening 31 of the base 30. The second air filter 50 has a laminated structure including an electrostatic filtering member 51, which includes polymer fibers charged with static electricity, and a urethane sheet 52, which is flat and functions as a cushion. The urethane sheet 52 is located at the downstream side of the frame 33 of the base 30 and the upstream side of the electrostatic filtering member 51. As shown in FIG. 8, the frame 33 of the base 30 includes U-shaped grooves, or U-shaped retainers 35, which hold edges of the second air filter 50. The U-shaped retainers 35 include a plurality of holding portions, or tabs 35a, which extend inward from the frame 33 into the opening 31. The tabs 35a cooperate with opposing upstream holding portions to hold the edges of the second air filter 50. Accordingly, the upstream side of the urethane sheet 52, which is the upstream one of the two members forming the second air filter 50, is supported in a state abut against the frame 33 of the base 30, and the edges of the urethane sheet 52 are forced into the U-shaped retainers 35. As shown in FIGS. 8 and 9, the self-propelled cleaning unit 60, when located at the standby position, does not lie over the second air filter 50. The second air filter 50 may be coupled to and removed from the frame 33 of the base 30 in a direction generally perpendicular to the filtering surface of the second air filter 50.

The electrostatic filtering member 51 of the second air filter 50 includes a filtering sheet, which has a plurality of pleats. The electrostatic filtering member 51 captures particles of dust that are finer than the particles of dust captured by the first air filter 40. The urethane sheet 52, which functions as a cushion, facilitates the coupling of the edges of the second air filter 50 to the U-shaped retainers 35.

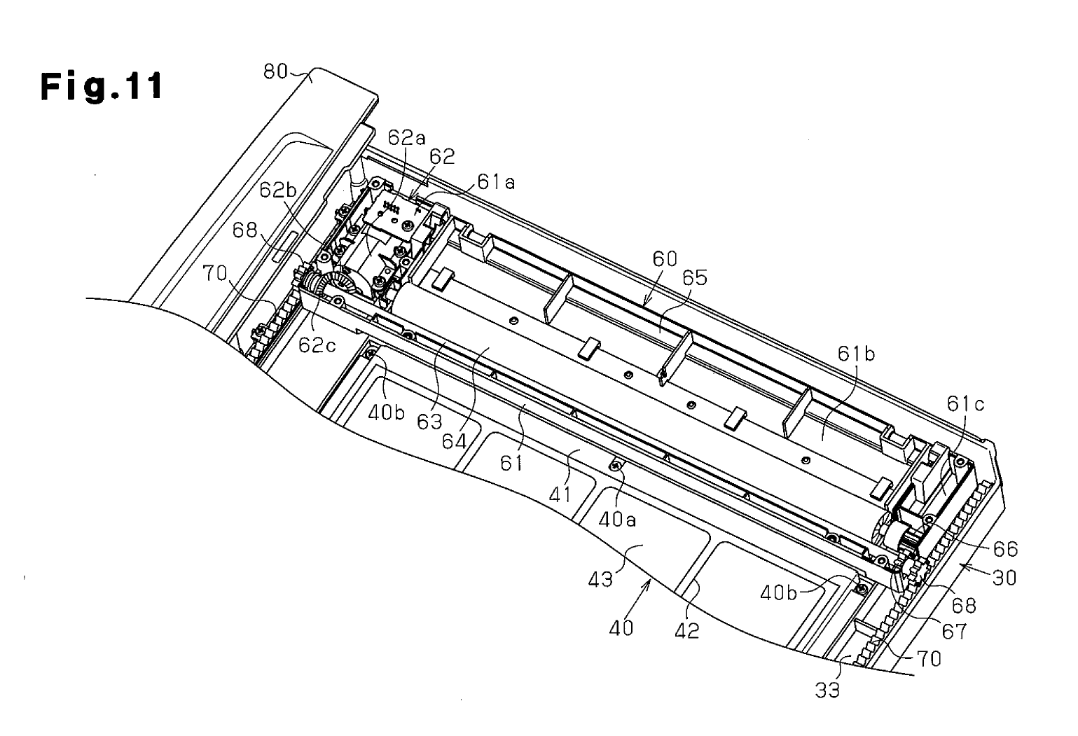

FIG. 9 shows the self-propelled cleaning unit 60 partially in cross-section. FIG. 11 shows the interior of the self-propelled cleaning unit 60. The self-propelled cleaning unit 60 is arranged at the upstream side of the filter unit 3 and includes an elongated and level housing 61. The longitudinal direction of the housing 61 is generally parallel to the left and right sides of the first air filter 40. As shown in FIG. 11, the housing 61 is partitioned into a drive compartment 61a, which accommodates a drive unit 62, a dust removal compartment 61b, which accommodates a transmission shaft 63, a rotation brush 64 (cleaning brush), a dust box 65, and a clutch compartment 61c, which accommodates a one-way clutch 66.

The drive unit 62 includes a motor 62a and bevel gears 62b and 62c. The motor 62a includes an output shaft, which extends perpendicular to the longitudinal direction of the housing 61. The bevel gear 62b is arranged on the output shaft of the motor 62a. The bevel gear 62c is arranged on a basal end of the transmission shaft 63 in engagement with the bevel gear 62b. Torque is transmitted from the motor 62a to the transmission shaft 63.

The clutch compartment 61c accommodates a spur gear 67 and the one-way clutch 66. The spur gear 67 is arranged on a distal end of the transmission shaft 63. The one-way clutch 66 is arranged on a shaft 64a of the rotation brush 64. The transmission shaft 63 has two ends projecting outward from the housing 61. A pinion 68 is arranged on each end of the transmission shaft 63. Each pinion 68 is engaged with the corresponding rack 70.

The dust removal compartment 61b occupies most of the housing 61 in the housing 61 leaving space for only the drive compartment 61a and the clutch compartment 61c. The length of the dust removal compartment 61b is about the same as that of the left and right sides of the first air filter 40. The transmission shaft 63, rotation brush 64, and dust box 65 are arranged in the dust removal compartment 61b in this order from the side closer to the first air filter 40. The lengths of the transmission shaft 63, rotation brush 64, and dust box 65 are about the same as the left and right sides of the first air filter 40.

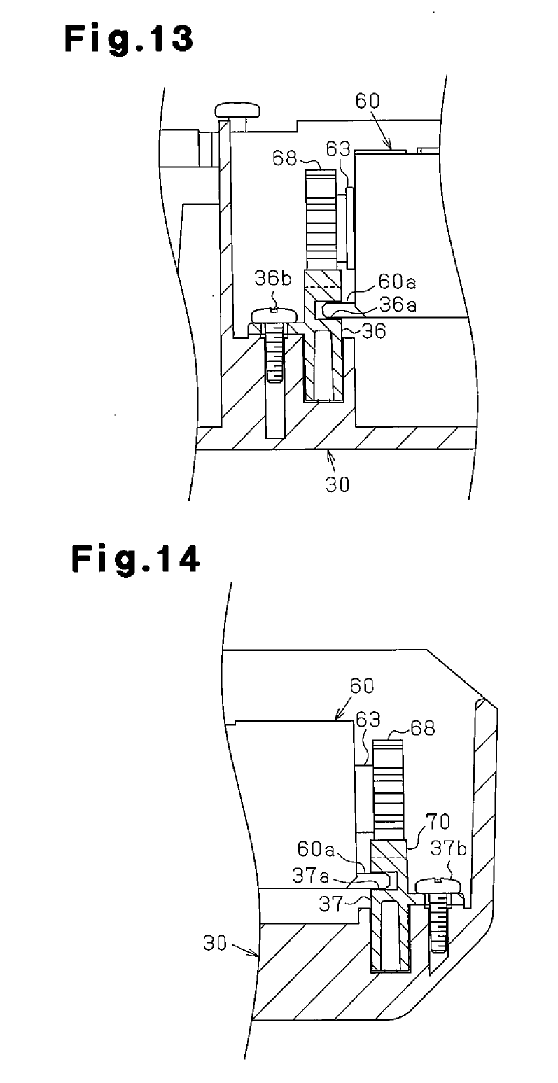

The motor 62a rotates the transmission shaft 63 through the bevel gears 62b and 62c. The pinions 68 at the two ends of the transmission shaft 63 are engaged with the corresponding racks 70. The gear mechanism of the pinions 68 and racks 70 convert rotation of the transmission shaft 63 to linear motion of the self-propelled cleaning unit 60. Accordingly, the motor 62a drives the self-propelled cleaning unit 60 from the standby position shown in FIG. 5 to the return position shown in FIG. 12. A sensor (not shown) detects the self-propelled cleaning unit 60 when moved to the return position. In response to such detection, the motor 62a produces reverse rotation and returns the self-propelled cleaning unit 60 to the standby position. In one example, the pinions 68 are rotated in the counterclockwise direction as viewed from the front wall 11 when the self-propelled cleaning unit 60 moves from the standby position of FIG. 5 to the return position of FIG. 12. The pinions 68 are rotated in the clockwise direction as viewed from the front wall 11 when the self-propelled cleaning unit 60 moves from the return position of FIG. 12 to the standby position of FIG. 5. As shown in FIGS. 13 and 14, planar projections 60a project from front and rear walls of the housing 61. Seats 36 and 37 respectively support the two racks 70 of the base 30. Grooves 36a and 37a are respectively formed on side walls of the seats 36 and 37 to receive the projections 60a in a movable manner. The projections 60a and the grooves 36a and 37a smoothes the movement of the self-propelled cleaning unit 60 and lowers the vibrations of the self-propelled cleaning unit 60. Screws 36b and 37b shown in FIGS. 13 and 14 fix the seats 36 and 37 to the base 30.

The rotation brush 64 includes a shaft 64a, which is formed from metal or resin, and a brushing member 64b, which is wound around the shaft 64a. The brushing member 64b includes bristles or fins extending outward in the radial direction from the shaft 64a. The one-way clutch 66 is arranged on a distal end of the shaft 64a.

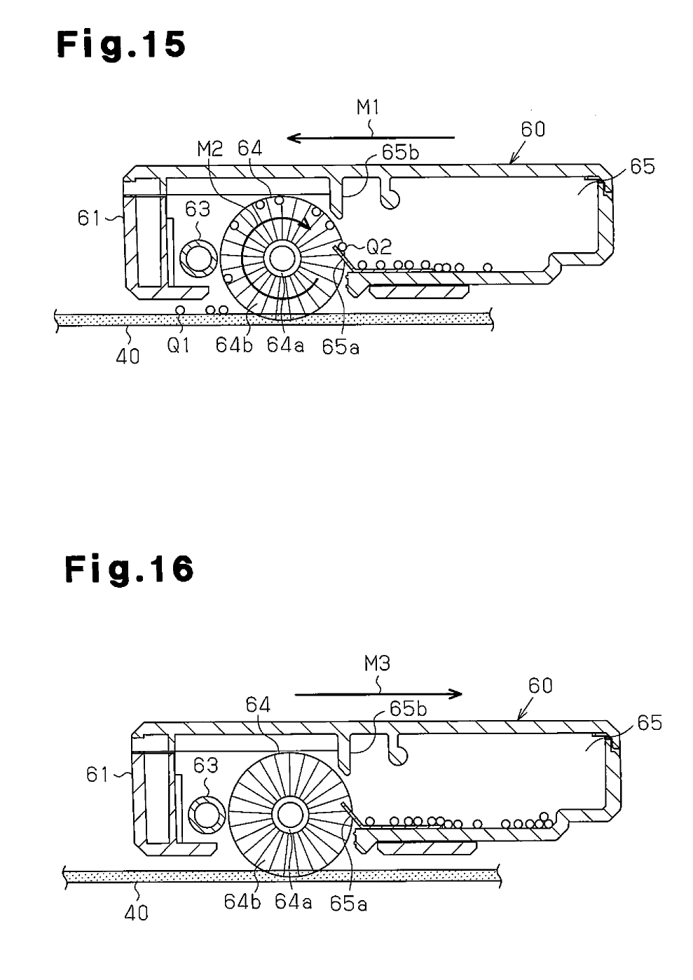

Referring to FIG. 15, distal ends of the bristles or fins of the rotation brush 64 extend from the dust removal compartment 61b toward the upstream surface of the first air filter 40. The dust box 65 is formed at the rear of the rotation brush 64 with respect to the direction in which the self-propelled cleaning unit 60 moves from the standby position to the return position. The distal ends of the bristles or fins of the rotation brush 64 enter the dust box 65 from an inlet of the dust box 65.

As shown in FIGS. 15 and 16, a comb-shaped dust remover 65a is arranged in the inlet of the dust box 65. The dust remover 65a removes dust from the distal ends of the bristles or fins of the rotation brush 64. In the illustrated example, the dust remover 65a includes comb teeth extending diagonally from the inner surface of the dust box 65. A partition wall 65b extends toward the dust remover 65a at the inlet of the dust box 65. The partition wall 65b prevents dust, which is removed from the rotation brush 64 by the dust remover 65a and collected in the dust box 65, from being scattered out of the dust box 65.

As shown in FIG. 1, the filter unit 3 includes a connector 90, which is connectable to a connector 91 of the outer case 1. The connector 90 may be arranged behind the handle 80 and beside the base 30. A power supply and a signal line connect the connector 90 to the drive unit 62. Connection of the connector 90 of the filter unit 3 to the connector 91 of the outer case 1 supplies the filter unit 3 with power and operates the filter unit 3 based on commands from an operation unit or control unit of the video projector. When the filter unit 3 is slid into and coupled to the outer case 1, the connector 90 of the filter unit 3 becomes connected to the connector 91 of the outer case 1. In the illustrated example, the connected connectors 90 and 91 are hidden by the handle 80.

The operation of the filter unit 3 will now be discussed.

The filter unit 3 is coupled to the video projector from the front wall 11. This connects the connector 90 of the filter unit 3 to the connector 91 of the outer case 1. The filter unit 3 is controlled in correspondence with the operation of the video projector. For example, to activate the drive unit 62, a control signal is provided via the connector 91 of the outer case 1 and the connector 90 of the filter unit 3 to the drive unit 62.

The filter unit 3 is operated when, for example, a filter sensor (not shown) detects clogging of the first air filter 40. Although not particularly limited, the filter sensor detects an increase in the current of fan motor (not shown) that corresponds to an increase in the intake resistance.

When the motor 62a of the filter unit 3 is activated, the transmission shaft 63 and the pinions 68 are rotated to move the self-propelled cleaning unit 60 from the standby position shown in FIG. 5 to the return position shown in FIG. 12 (refer to arrow M1 in FIG. 15). During the movement, the rotation brush 64 rotates in the direction of arrow M2 while pressing the first air filter 40. This removes dust particles Q1 from the first air filter 40. The comb-shaped dust remover 65a at the inlet of the dust box 65 removes dust particles Q2 from the rotation brush 64. The dust particles Q2 are collected in the dust box 65.

When a sensor (not shown) detects that the self-propelled cleaning unit 60 has reached the return position shown in FIG. 12, the motor 62a produces reverse rotation. This moves the self-propelled cleaning unit 60 to the standby position shown in FIG. 5 (refer to arrow M3 in FIG. 16). When the self-propelled cleaning unit 60 moves to the standby position, the one-way clutch 66 cuts the transmission of torque from the motor 62a to the rotation brush 64. Thus, the rotation brush 64 does not rotate in the reverse direction. This prevents the dust particles Q2 collected from the first air filter 40 from being scattered.

The operation of the filter unit 3 described above cleans the first air filter 40. Accordingly, the number of times required to clean and replace the first air filter 40 is significantly reduced in comparison to when manually cleaning the first air filter 40. However, the amount of dust on the first air filter 40 increases when the video projector is used over a long period of time. Thus, the first air filter 40 should be removed and cleaned or replaced with a new one after a certain period elapses. In the present embodiment, maintenance is performed on the first air filter 40 as described below.

First, the filter unit 3 is drawn out and removed from the front wall 11 of the video projector. This disconnects the connector 90 of the filter unit 3 and the connector 91 of the base 30 without the need for directly touching the connectors 90 and 91. Thus, connectors and plugs do not have to be manually removed from the filter unit 3.

Then, the drawn out filter unit 3 is turned upside down as shown in FIG. 5. In a non-cleaning state, the self-propelled cleaning unit 60 is located at the standby position. This allows for the screws 40a and 40b to be unfastened in a direction perpendicular to the filtering surface. Thus, the first air filter 40 may be removed from the base 30 in a direction perpendicular to the filtering surface without interference from the self-propelled cleaning unit 60 so that the first air filter 40 can be properly washed or cleaned. When necessary, the first air filter 40 may be replaced by a new one. The first air filter 40, which is new or washed (cleaned), is set at a position corresponding to the opening 31 of the base 30 and fastened to the base 30 by the screws 40a and 40b without being interfered by the self-propelled cleaning unit 60.

To perform maintenance on the second air filter 50 such as washing, cleaning, and replacement, the second air filter 50 may easily be removed from the frame 33 of the base 30 in a direction perpendicular to the filtering surface. For example, the filter unit 3 is removed from the front wall 11 of the video projector. Then, the edges of the second air filter 50 are pulled out of the U-shaped retainers 35 to remove the second air filter 50 from the base 30. When the second air filter 50, which is new or washed (cleaned) is coupled to the base 30, the upstream side of the urethane sheet 52 is arranged in contact with and supported by the frame 33 of the base 30. Parts of the edges of the laminated body of the electrostatic filtering member 51 and the urethane sheet 52 are forced into the U-shaped retainers 35. This facilitates the coupling of the second air filter 50 to the base 30. In this manner, the second air filter 50 is easily coupled to and removed from the base 30 without being interfered by the self-propelled cleaning unit 60.

The filter unit 3 is one example of an air filter device. The components of the filter unit 3 excluding the air filters 40 and 50 may be referred to as an air filter cleaning device.

The air filter device and video projector of the present embodiment has the advantages described below.

(1) The filter unit 3 includes the self-propelled cleaning unit 60, which moves on the filtering surface at the upstream side of the first air filter 40 from the standby position to the return position. Thus, the rotation brush 64 can remove dust from the first air filter 40.

(2) The first air filter 40 does not have to be moved on the base 30 to remove dust from the first air filter 40. This allows for the space that accommodates the first air filter 40 to be smaller and the filter unit 3 to be reduced in size.

(3) Fasteners, such as the screws 40a and 40b, arranged at positions that do not overlap in the vertical direction with the self-propelled cleaning unit 60 at the standby position fasten the first air filter 40 to the base 30. Thus, the self-propelled cleaning unit 60 does not interfere with the removal of the first air filter 40 when replacing or cleaning the first air filter 40. The self-propelled cleaning unit 60 also does not interfere with the coupling of the first air filter 40 to the base 30 subsequent to maintenance.

(4) In a non-cleaning state, the self-propelled cleaning unit 60 is located at a position at which it is not overlapped with the filtering surfaces of the first air filter 40 and the second air filter 50. This maximizes the effective area of the first air filter 40 and the second air filter 50.

(5) The first air filter 40, second air filter 50, base 30, rotation brush 64, dust box 65, and motor 62a are unitized to form the filter unit 3. Accordingly, removal of the filter unit 3 from a product to which it is applied, such as the main body of the video projector, facilitates maintenance of the first air filter 40 and the second air filter 50. Further, the filter unit 3 may be manufactured separately from the product to which it is applied. This facilitates manufacturing management and lowers manufacturing costs.

(6) The first air filter 40 can be coupled to and removed from the frame 33 of the base 30 in a direction generally perpendicular to the filtering surface. This allows for the first air filter 40 to be replaced within a small working space. Further, the first air filter 40 may be coupled to the base 30 by simple fasteners such as the screws 40a and 40b.

(7) The second air filter 50 is coupled to the downstream side of the base 30 to captures particles of dust that are smaller than those captured by the first air filter 40. The first air filter 40 and the second air filter 50 can be coupled to and removed from the frame 33 of the base 30 in a direction generally perpendicular to the filtering surface. Accordingly, maintenance work such as removal and replacement of the first air filter 40 and second air filter 50 may be performed within a small working space.

(8) The base 30 includes the U-shaped retainers 35, which hold the edges of the second air filter 50. For example, the base 30 supports the second air filter 50 by contacting the upstream surface of the second air filter 50 with the downstream surface of the base 30 and elastically inserting parts of the edges of the second air filter 50 into the U-shaped retainers 35. This facilitates the coupling of the second air filter 50 to the base 30 and simplifies the structure for coupling the second air filter 50.

(9) The pinions 68, which are coupled to the motor 62a, are rotated on the racks 70, which are coupled to the base 30, to move the self-propelled cleaning unit 60 along the upstream side of the first air filter 40. The filter unit 3, which includes a drive mechanism such as the self-propelled cleaning unit 60, facilitates manufacturing management since the filter unit 3 may be manufactured separately from the product to which it is applied. Further, the coupling of the filter unit 3 to the product to which it is applied facilitates coupling.

(10) The rotation brush 64 is a cleaning brush. The self-propelled cleaning unit 60 moves as the rotation brush 64 rotates to remove the dust particles Q1 from the first air filter 40. This improves the efficiency for removing dust from the first air filter 40.

(11) The dust particles Q2 removed from the first air filter 40 by the rotation brush 64 is collected in the dust box 65 as the rotation brush 64 rotates. Thus, the removed dust particles Q2 are continuously collected in the dust box 65.

(12) The video projector includes the filter unit 3, which is arranged on the air inlet 12 for cooling air that cools the optical system elements. This allows the video projector to be reduced in size, increases the cleaning efficiency of the air filters 40 and 50, and simplifies maintenance of the air filters 40 and 50.

It should be apparent to those skilled in the art that the present invention may be embodied in many other specific forms without departing from the spirit or scope of the invention. Particularly, it should be understood that the present invention may be embodied in the following forms.

In the first air filter 40, the rim 41 and the grid 42 may be discrete from the porous filtering element 43, which captures dust that is suspended in air. In this case, after manufacturing each component, the components may be integrated with one another by an adhesive agent or the like.

The first air filter 40 is coupled to the frame 33 of the base 30 preferably by fasteners that allow for the first air filter 40 to be removed from and coupled to the base 30 in a direction perpendicular to the filtering surface. The fasteners are the screws 40a and 40b but may be an engagement structures such as elastic hooks.

The first air filter 40 is preferably coupled to and removed from the base 30 by the fasteners in a direction perpendicular to the filtering surface but not limited in such a manner. For example, the first air filter 40 may be coupled to and removed from the base 30 in any one of front, rear, left, and right directions.

The U-shaped retainers 35 do not have to support the four sides of the second air filter 50 and may support three or less sides of the second air filter 50. The tabs 35a of the U-shaped retainers 35 are arranged parallel to the pleats of the electrostatic filtering member 51 on the left and right sides of the frame 33 of the base 30 but may be replaced by a single tab extending throughout the entire length of each side of the frame 33.

The filter unit 3 may be automatically operated whenever the video projector completes projection of an image. The filter unit 3 may also be periodically operated at a controlled timing or in response to operation of a cleaning switch.

The optical system of the video projector is not limited to the illustrated example and may be an optical system for a single-LCD projector, for example.

The filter unit 3 is not limited to a video projector and may be applied to various air conditioning systems such as an air conditioner or a dust collector.

The present examples and embodiments are to be considered as illustrative and not restrictive, and the invention is not to be limited to the details given herein, but may be modified within the scope and equivalence of the appended claims.

1. An air filter device comprising:
a base including a frame that defines an opening through which air is drawn;
a first air filter that captures dust from the air drawn through the opening, wherein the first air filter is fastened to the frame of the base by a fastener, and the first air filter includes a filter surface; and
a self-propelled cleaning unit coupled to the base, wherein the self-propelled cleaning unit moves along the filter surface of the first air filter when cleaning the first air filter and is located at a standby position on the frame of the base when in a non-cleaning state, and the self-propelled cleaning unit includes
a cleaning brush that removes dust from the first air filter,
a dust box that collects dust removed by the cleaning brush, and
a motor that moves the self-propelled cleaning unit,
wherein the self-propelled cleaning unit, when located at the standby position, lies away from the entire filter surface of the first air filter and the fastener.

2. The air filter device according to claim 1, wherein the air filter device is a unit including the first air filter, the base, the cleaning brush, the dust box, and the motor, and the unit is coupled in a removable manner to a product to which the unit is applied.

3. The air filter device according to claim 2, wherein the fastener fastens the first air filter to the frame of the base in a direction generally perpendicular to the filter surface, and wherein the fastener and the first air filter are removed from the frame in a direction generally perpendicular to the filter surface.

4. The air filter device according to claim 3, further comprising a second air filter coupled to the base at a position downstream from the first air filter, wherein the second air filter captures particles of dust that are smaller those captured by the first air filter, and the second air filter is coupled to and removed from the frame of the base in a direction generally perpendicular to a filter surface of the second air filter.

5. The air filter device according to claim 4, wherein the base includes a U-shaped retainer that supports at least part of an edge of the second air filter, and the edge of the second air filter is elastically inserted into the U-shaped retainer and thereby supported by the base.

6. The air filter device according to claim 1, wherein the self-propelled cleaning unit further includes a rack, which is coupled to the base, and a pinion, which is coupled to the motor, wherein the rack and pinion are engaged with each other to move the self-propelled cleaning unit along the filter surface of the first air filter.

7. The air filter device according to claim 6, wherein the cleaning brush is a rotation brush that rotates to remove dust from the first air filter while moving along the filter surface of the first air filter.

8. The air filter device according to claim 7, wherein the cleaning brush rotates to collect the dust removed from the first air filter in the dust box.

9. A video projector comprising:
an optical system; and
the air filter device according to claim 1 arranged in an air intake port that permits passage of air for cooling the optical system.

10. An air filter cleaning device comprising:
a base including a frame that defines an opening through which air is drawn;
a flat filter element coupled to the frame to capture dust from the air passing through the opening;
a fastener that fastens the filter element to the frame; and
a self-propelled cleaning unit that cleans an upstream side of the filter element, wherein the self-propelled cleaning unit is coupled to the base to be movable back and forth between a standby position and a return position located away from the standby position, the self-propelled cleaning unit is located at the standby position in a non-cleaning state, and the self-propelled cleaning unit includes
a rotation brush that removes dust from the upstream side of the filter element,
a dust box that collects dust removed by the rotation brush,
a motor that moves the self-propelled cleaning unit, and
an elongated and level housing that accommodates the rotation brush, the dust box, and the motor;
wherein when the self-propelled cleaning unit is located at the standby position, the housing lies along only the frame and lies away from the entire upstream side of the filter element and the fastener.

11. The air filter cleaning device according to claim 10, wherein
the filter includes one straight side,
the rotation brush includes a rotation shaft, which extends parallel to the straight side of the filter element, and a bristle or fin that extends outward in a radial direction from a portion of the rotary shaft that corresponds to the straight side of the filter element, and
when the self-propelled cleaning unit moves and the rotation brush rotates about the rotation shaft in just one direction, the rotation brush cleans the entire upstream side of the filter element.

12. The air filter cleaning device according to claim 10, wherein the filter element is a most outward filter element among a plurality of filter elements of the air filter cleaning device.

13. The air filter cleaning device according to claim 10, wherein the air filter cleaning device is for use with a video projector.
